(19) United States
(12) Patent Application Publication
(10) Pub. No.: US 2002/0184347 A1
(43) Pub. Date: Dec. 5, 2002

(54) Configuration of a machine vision system over a network

(76) Inventors: Steven Olson, Portland, OR (US); Tamostu Tanabe, Lake Oswego, OR (US); John McGarry, Tigard, OR (US)

Correspondence Address: ARTHUR J. O'DEA, LEGAL DEPARTMENT, COGNEX CORPORATION, ONE VISION DRIVE, NATICK, MA, 01760-2077, US

(21) Appl. No.: 09/872,934

(22) Filed: Jun. 2, 2001

(51) Int. Cl. G06F 15/177

(52) U.S. Cl. 709/220

(57) ABSTRACT

A method is disclosed for configuring a machine vision system over a network, wherein the machine vision system includes a heterogeneous set of vision processors (VPs), and at least one host having a user interface (UI). The method includes the steps of sending VP characteristic information over the network from a VP to a host having a UI; and using the UI to configure the VP via the network. Thus, it is no longer necessary to match a UI with the VP it will connect with, which simplifies installation, configuration, and extension of multiple VP vision systems. The invention also enables a single UI to connect to and configure VPs with substantially different I/O support, communications protocols, and vision functionality.

### COPYRIGHT NOTICE

The disclosure of this patent document contains material that is subject to copyright protection. The copyright owner has no objection to the facsimile reproduction by anyone of the patent document or the patent disclosure, as it appears in the United States Patent and Trademark Office patent file or records, once a patent is issued on this application, but otherwise reserves all copyright rights whatsoever.

### FIELD OF THE INVENTION

This invention relates to the configuration of machine vision systems, and particularly to configuration of a remote vision processor over a network.

### BACKGROUND OF THE INVENTION

A machine vision system includes a collection of one or more vision processors (VPs) for at least processing and interpreting images, and optionally one or more user interfaces (UIs) for at least enabling a user to interact with and/or control a VP. Each VP is connected to one or more electronic cameras through which the VP “sees” its environment, i.e., acquires an image of a scene.

With reference to FIG. 1, the UI and the VP may coexist on the same computer platform, in which case the camera 11 is connected via acquisition circuitry 12 to a general purpose processor 13 (such as a microprocessor, digital signal processor, or CPU). The general purpose processor runs a program that implements a VP 14 and a UI 15 that communicate with one another via shared memory. The UI interfaces with a user operating one or more input devices (such as a control pad, a keyboard, or a mouse) via input device circuitry 16 and provides a graphical display to the user on a display device (such as an LCD display or a computer monitor) via display circuitry 17.

Alternatively, the VP and the UI may exist on separate computer systems. This configuration shares the components of the single-computer vision system, but runs the VP on a distinct general purpose processor from the UI. Referring to FIG. 2, a camera 21 is connected via acquisition circuitry 22 to a general purpose processor 23. This processor runs a program that implements a VP 24 and communicates via communications circuitry 25 across a communications channel 26 (such as an RS232 serial connection or an ethernet connection) to the computer running the UI. The UI computer 32 houses a general purpose processor 28 that runs a program implementing the UI 29. The UI communicates with the VP computer via communications circuitry 27 and the communications link 26. A user may control the UI via one or more input devices connected to the input device circuitry 30 and view graphical output via display circuitry 31 on a display device.

Referring to FIG. 3, if the communications channel provides access to a network, several additional connection schemes are also possible: each UI 35 can communicate via that network 36 with one of many networked VPs 37, 38, 39, as shown in FIG. 3. When a user (either a developer who will configure a VP for a specific vision task, or an operator who will monitor the system during the operation phase) desires to communicate with a particular VP, the user selects the new VP from a list provided by the UI and instructs the UI to establish a connection. In this way, many UIs may control each VP, and each UI may control many VPs. A collection of VPs may work together to solve a complex vision problem—in this case the each VP in the collection solves a particular subset of the overall vision problem.

There are three modes of operation of a machine vision system, during which different actions take place on both the UI and the VP:

1. Connection—using the UI, the developer or the operator selects a VP from a list of all available VPs, possibly displayed in a menu by the UI. UI establishes initial communications with the VP. The connection phase establishes data communications between the UI and the VP. One embodiment of such a data connection is an application layer connection in the OSI communication model.

2. Configuration—through the UI, developer configures the connected VP for a specific vision task.

3. Operation - the VP executes the sequence of functions defined by the user during the configuration phase. The UI may be used by an operator to monitor the outputs of the VP, or may be disconnected from the VP, allowing the VP to run standalone.

Referring to FIG. 4, when designing a vision application, a developer typically connects to a specific VP 41 and then performs one or more cycles of configuration 42 and operation 43. After the developer is satisfied with the configuration of the first VP, the developer may connect to a second VP 44 and complete a cycle of configuration 45 and operation 46 of that system. This process may be repeated for additional available VPs of the same type.

In response to user actions, the UI issues commands to and receives responses from an attached VP according to a fixed application protocol. In order to communicate effectively, both the UI and the VP must be “matched”—both UI and VP must agree a-priori on the specific protocol that they use. In addition, the UI must “know” all possible configurations of the VP. For example, the addition of a new VP function to perform optical character recognition (OCR) requires upgrading the UI so that the user may configure vision applications that perform OCR. This means that when designing a vision application as described above, a developer must use a vision system comprised of a homogeneous set of VPs or must operate a different UI for each different type of VP comprising the vision system.

The fact that the UI must be matched with any VP with which it will communicate is a significant problem for known vision systems when updating and extending the functionality of existing VPs, and when introducing new VPs with different functionality from earlier versions. The kinds of functionality that may be built into new VPs include, for example

New (human) language support

Changes to the numbers and types of I/O devices supported

Enhancements to VP performance (by improving existing algorithms or by upgrading VP hardware)

Addition of new vision tools (such as OCR)

Addition of I/O functions (e.g. support of new network protocols for VP->external device communications)

Addition of new runtime graphical controls and displays

Removal of functions to provide cost advantages over full-featured systems

Presently, known UIs cannot support this different VP functionality without obtaining a new release from the manufacturer. This is inefficient, inconvenient, costly, and requires continuing maintenance. Moreover, known vision systems systems fail to allow a single UI to connect with a heterogeneous set of VPs.

### SUMMARY OF THE INVENTION

In one general aspect, the invention is a method for configuring a machine vision system over a network, wherein the machine vision system includes a heterogeneous set of vision processors (VPs), and at least one host having a user interface (UI). The method includes the steps of sending VP characteristic information over the network from a VP to a host having a UI; and using the UI to configure the VP via the network.

In a preferred embodiment, the VP characteristic information includes a plurality of VP characteristics. In an alternate preferred embodiment, the VP characteristic information includes a plurality of VP identification codes; and a plurality of functions executable on the VP.

Alternatively, the VP characteristic information can include only a VP identification code, or only an executable program. The executable program is adapted to configure a plurality of VP functions and parameters. The executable program may be run on a thin client so as to provide a UI.

In another preferred embodiment, the VP characteristic information includes a plurality of VP identification codes, or a plurality of functions.

In another aspect, sending VP characteristic information over the network includes connecting to the VP using a thin client. The thin client can be a web browser.

The invention enables a single UI to connect with a heterogeneous variety of VPs. This is accomplished by extending the application protocol to include a more sophisticated connection phase. During this new connection phase, the VP communicates its capabilities to the UI. The UI then alters the content presented to a user to match the capabilities of the currently connected VP. In this way a single UI may connect to a variety of VPs with differing capabilities and available functions.

Enabling a single UI to connect to a variety of different types of VPs provides significant cost and ease-of-use benefits. With the current invention it is no longer necessary to match a UI with the VP it will connect with, which simplifies installation, configuration, and extension of multiple VP vision systems. Using the current invention it is possible for a single UI to connect to and configure VPs with substantially different I/O support, communications protocols, and vision functionality.

### BRIEF DESCRIPTION OF THE DRAWING

The invention will be more fully understood from the following detailed description, in conjunction with the following figures, wherein:

FIG. 1 is a block diagram showing a standalone machine vision system in which both the vision processor and the user interface are realized in a single computer.

FIG. 2 is a block diagram showing a machine vision system comprised of a user interface computer connected with a vision processor computer via a general-purpose communications link.

FIG. 3 is a block diagram showing a networked machine vision system comprised of a plurality of vision processor computers connected via a network to a user interface computer.

FIG. 4 shows the sequence of operations performed by a developer setting up a two-VP vision system.

FIG. 5 shows how a preferred UI embodiment presents a list of VP functions and descriptions.

FIG. 6 shows how a preferred UI embodiment presents the parameter list of a single VP function.

FIG. 7 shows a block diagram of the invention with the VP transferring a description of its capabilities to the UI.

FIG. 8 shows an expanded enumerated type in the parameter list of a single VP function.

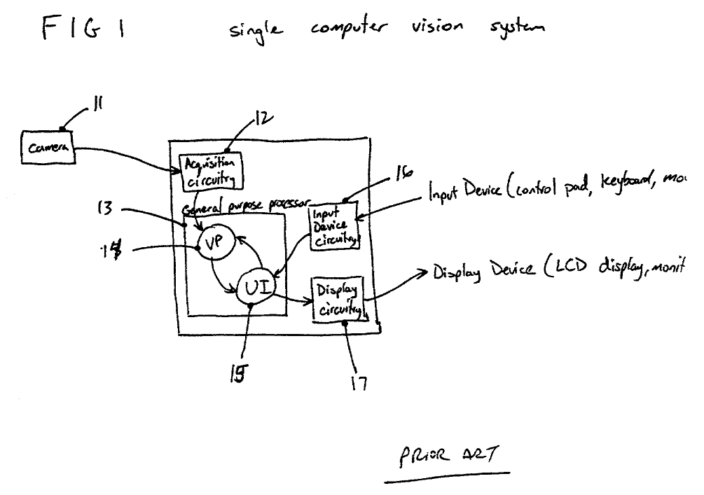

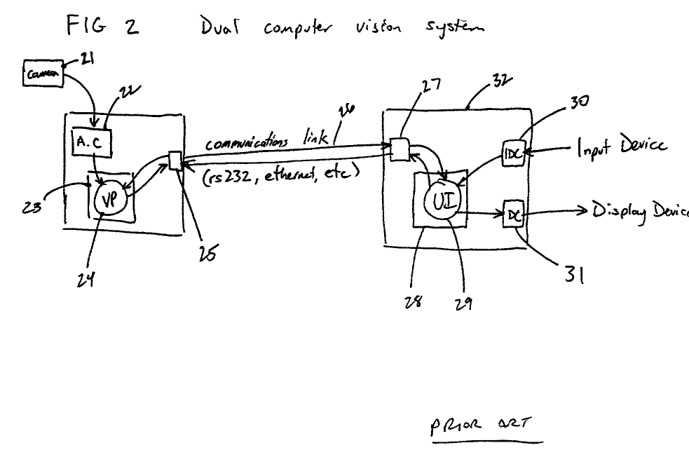

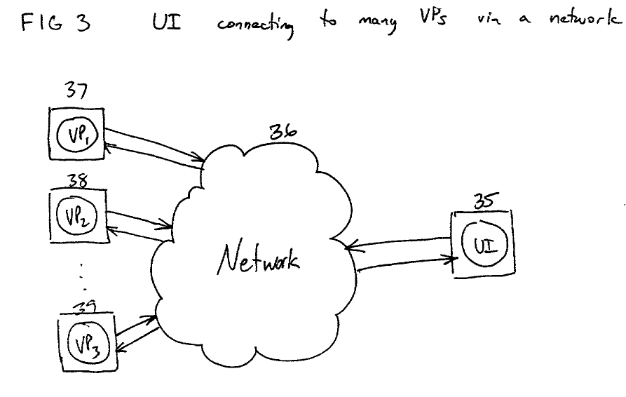

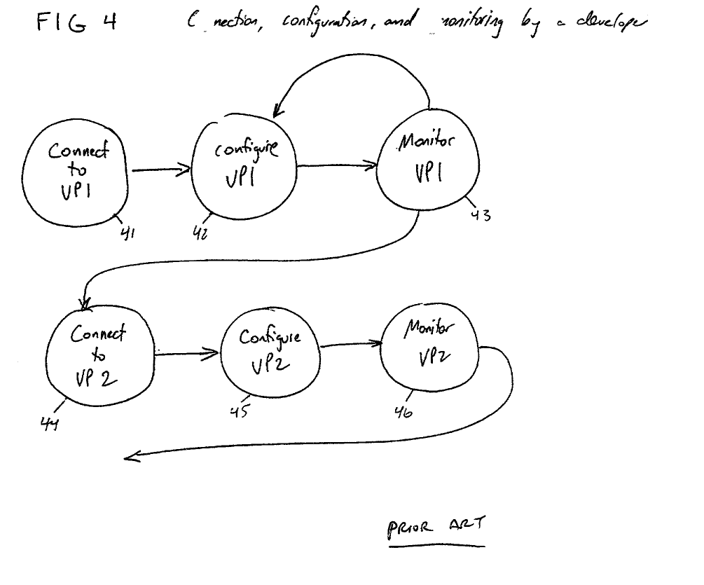

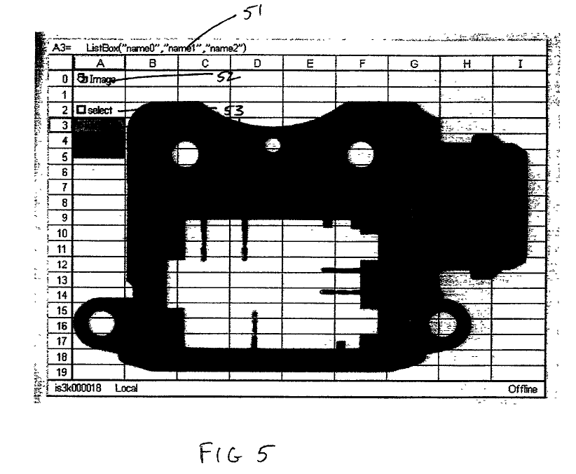

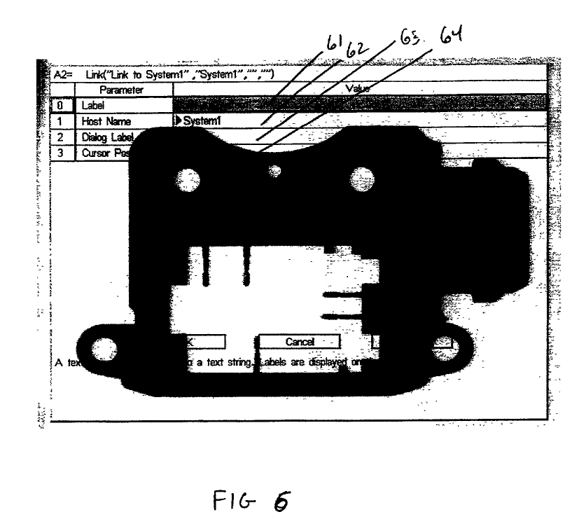

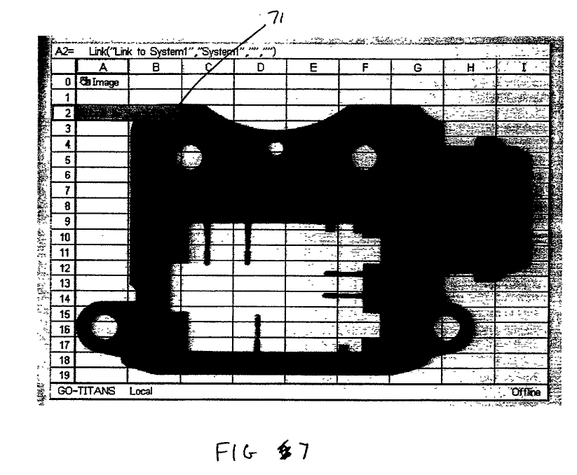

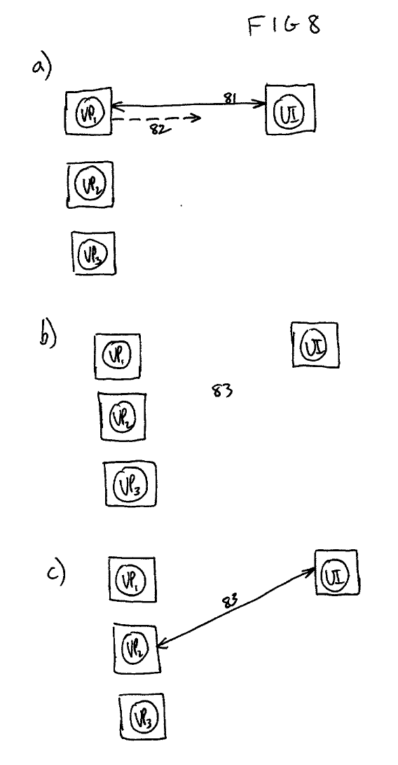

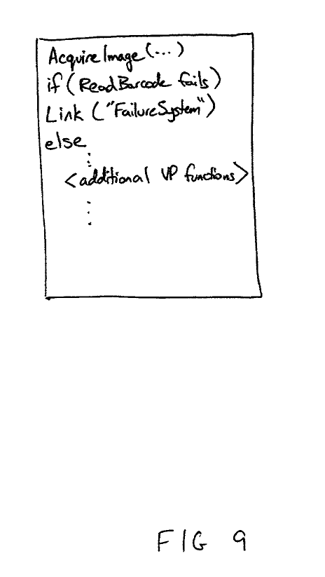

### DETAILED DESCRIPTION OF THE INVENTION

How to accomplish the extension of an existing application layer protocol for communications between a UI and a VP will now be explained. Typical client/server protocols are command based, which means that the client (the UI) issues commands to the server (the VP), and the server issues responses to the client. Therefore, all that must be added to an existing protocol is a single command that the UI issues upon connecting to the VP. When the VP receives this command it responds by sending data corresponding to its capabilities to the UI. The exact nature of this data depends upon the

In a preferred implementation, the VP sends a series of numeric codes along with a list of executable functions and sufficient supporting data so that the UI can effectively guide the user in the setup of an “unknown” machine vision application. In another possible implementation, the VP sends a numeric or text identity code to the UI during the connection phase. The UI interprets the VP-supplied identity code and enables configuration of only the functionality “understood” by the VP. In a third implementation, the communications from the VP to the UI is in the form of an executable program that contains the capability of configuring all VP functions and parameters.

The operation of any VP may be decomposed into the sequenced execution of a set of functions. A typical VP operation cycle may consist of the execution of three functions, for example:

1. Acquirelmage, a function which reads an image from a digital camera connected to the VP

2. ReadBarcode, a function that locates and decodes a UPC barcode represented in the image.

3. WriteSerial, a function which writes the decoded string to an external computer or device via an RS232 serial port built into the VP

The function names (italics) are completely arbitrary and need not be explicitly represented on the VP.

Each function may have one or more parameters: the function produces a result based on some combination of its input parameters. For example, a mathematical function named cos might have a single parameter and as its result generate the cosine of the angle specified by its (numeric) parameter. A more complex function, binarize might take a single parameter corresponding to a two-dimensional grayscale image and produce as its result the two-dimensional black-and-white image that most closely approximates the parameter image. The parameters of any function may be constants, or may be the results of other functions.

In addition to standard functions that merely transform parameters to results, there are two other classes of functions important to all VPs: input functions and output functions. Input functions read information from hardware devices: their results vary depending on the state of these devices. A centrally important function for any machine vision system is one that acquires an image from a camera (the Acquirelmage function described earlier): in this case the function's result is an image that closely approximates the state of the imaging device or sensor when the function was executed. Other input functions may read, via specialized devices, the states of digital input lines, data sent on a serial port or ethernet network, or any other external entity that may be connected to a compatible input device.

Like input functions, output functions interact with specialized hardware devices. However, their behavior is to assert a state upon the connected external entity. The particular state that each function asserts is based on its parameters: a function WriteSerial may take a single input parameter, a string of text characters, and cause that string of characters to be written out through the system's serial port. Other output functions might assert particular voltage levels onto individual output control lines, write data out through an ethernet network, or cause the UI to display graphics (intended to communicate to a user about the values of the function's parameters).

The UI together with a host operating system (OS) provides a convenient environment for user configuration of a vision application. Shown in FIG. 5, a preferred embodiment of the UI presents a graphical representation of VP function categories 51, VP function subcategories 52, and VP functions 53. The use can expand and collapse subcategories to view and hide the functions each group contains. The user moves the cursor 54, shown highlighting the function ReadBarCode, with an input device such as a mouse or a keyboard to a desired VP function. In response, the UI displays an associated function description string 55 which describes the use and syntax of the VP function to the user. Selecting the ReadBarcode function (by clicking a mouse button or pressing a keyboard key) causes the UI to display detailed configuration information for the ReadBarCode function (FIG. 6). The UI displays the function with input parameters 61 as well as more detailed information about each parameter. For each parameter, the parameter names 62 63 are shown in a column next to the parameter values 64 65. By moving the cursor 66, the user causes the UI to display the associated parameter description string 68. Depending on the implementation of the particular function, graphics 67 may describe input parameters or function results.

There are at least three methods that may be used to allow a single UI to configure a heterogeneous set of VPs. In all three methods, the VP 71 transfers across a communications channel 72 a block of data comprising a description of the VP's capability 73 to the UI 74. In the first method, the description is comprised of a numeric or text identification code is sent from the VP to the UI along with a description of the functions that the VP can execute. The UI enables configuration only of functions executable on the VP. In the second method, the description is comprised only of a numeric or text identification code. This method is simpler to implement than the first method, but does not allow the same degree of flexibility. In the third method, a thin client such as a Web browser connects to the VP and downloads a processor independent program from the VP (where the description is contained implicitly or explicitly within the program). This program, when executed by the client, provides a compatible UI within the client framework.

All three of these methods provide a means for a UI to communicate with a heterogeneous set of VPs. There are many possible reasons why VPs may differ, and it is very desirable to have the ability to access any of these systems from a single UI. VPs may run different versions of firmware with slightly different characteristics. VPs may be constructed as application specific VPs: they may be designed to solve a very narrow class of machine vision applications. VPs may be constructed with reduced capabilities for cost reasons or for hardware platforms with limited memory storage. Finally, as software and firmware technologies evolve, new tools and capabilities will be designed into future VPs—it is desirable for a UI installed today to function with currently available VPs as well as those that will be built in the future!

### METHOD 1

Using this method, a set of 0 or more VP characteristics is defined, and each characteristic is labeled with a number. VP characteristics are features of the VP that are convenient to have constrained when designing the UI. For example, typical characteristics represent hardware limits such as the number of available RS232 serial ports, the number of available digital inputs, and the horizontal and vertical size of the digital camera attached to the VP. Characteristics may also represent general software concepts such as the availability of specific communications protocol support or the software revision number.

When a UI connects to a VP, the VP transmits to the UI the set of characteristics broadly defining the type of VP. Using the example above, the VP might transmit the numeric sequence (1,10,640,480) to indicate the presence of one serial port, ten digital inputs and an acquisition size of 640×480 pixels. Any encoding of the enumerated values is possible: other options include human-readable strings, for example “serial 1 digital 10 acquisition 640 480” could be used to define the same VP characteristics.

We transfer the following set of characteristics from the VP to the UI during the connection phase:

Firmware revision number

Hardware serial number

System-specific global software configuration parameters

Contents of current VP program

RS232 serial port characteristics including

Number of serial ports

Hardware Configuration of each serial port including

Baud rate

Parity

Data bits

Stop bits

Hardware handshake

System-specific software configuration of each serial port (including transmission mode and related parameters)

Digital I/O characteristics including

Number of digital inputs

Number of digital outputs

System specific software configuration of each digital input (including operational modes for each input and output and related parameters)

Network parameters including

Ethernet MAC

Static IP address (if applicable)

Subnet Mask

Default Gateway

System Name

DNS Server address

System specific network parameters

The VP also sends the syntax of all functions that may be individually specified and executed by the VP. The UI receives the syntax specification and enables a user to construct a VP program by specifying the order of execution of these functions. Minimally, the syntax must include a list of VP function descriptions, where each function description is comprised of:

Function name

Number of parameters

Using this information the UI can guide the specification of valid VP functions.

A more complete implementation may contain the following:

List of text strings and associated numeric string Ids (string table).

List of VP function categories. Each function category is comprised of

List of VP function subcategories. Each function subcategory is comprised of

List of supported VP functions (including input and output functions). Each function is comprised of

Function name

String ID of function description string

Function result type (integer, floating point, image, text string, etc.)

Parameter list. Each parameter is comprised of

Parameter Name

Default value—the parameter value filled in when the function is initially created

Parameter type—the type of input parameter. The UI uses the parameter type to determine how the user may modify the value. Parameter type is one of BOOLEAN, INTEGER, FLOAT, STRING, or ENUMERATED.

Minimum value—the minimum legal value the parameter may hold

Maximum value—the maximum legal value the parameter may hold. Together, the minimum and maximum values and the type determine the

Optional enumerated list of string IDs for parameters of type ENUMERATED. ENUMERATED parameters may take one value from a small set of named parameters.

String ID of parameter description string

The UI uses this information to more appropriately guide the user in system configuration. As shown in FIG. 7, the function name 61, is prominently displayed when configuring an instance of a particular VP function. Also shown are parameter names 62 63, and currently selected values 64 65 for each parameter. The displayed format of each current value depends on the parameter type. For example parameters of numeric type are shown as floating point numbers 64, and parameters of enumerated type are shown as one of a list of enumerated strings 65.

FIG. 8 shows how the UI enables selection from a list 81 of string ID for parameters of enumerated type. The use may select one of the members of the list by moving the cursor 82 on top of the desired element and clicking a mouse button or pressing a specific keyboard key. The use of string IDs reduces the memory storage and communications bandwidth requirements. Since many functions in a given VP share parameter types help strings and descriptive text to be displayed to the user are transferred in a single string table. String IDs are numbers that specify a single string in the string table. This significantly reduces the amount of data in the function list.

The organization of VP functions into categories 51 and subcategories 52 (shown in FIG. 6) is very important to aid the user in selecting from the potentially large number of available functions. Two levels of grouping have proved sufficient in our systems, but VPs with fewer functions may benefit from fewer levels of grouping and VPs with more functions may benefit from more levels.

### METHOD 2

A simplification of Method 1, using the second method the VP transfers only a list of encoded characteristics. The description of VP functions is not sent to the UI. This greatly simplifies the implementation of the VP/UI protocol at the expense of flexibility. The main limitation of this method is that the complete set of characteristics and their possible values must be known when the UI is constructed and installed. If a new version of the VP is developed (perhaps with additional VP functions to support new vision applications), the UI needs to be upgraded as well.

Using Method 2, sets of available functions can be encoded as specific characteristic codes. This permits VPs to implement only a subset of all known executable functions, and to communicate the implemented subset to the UI. However, the set of all possible function must be identified when the UI is constructed. Therefore, as already noted, future extensions to VP functionality demand the replacement of the UI.

### METHOD 3

The most general and flexible of the three methods utilizes a general purpose “thin client” computer program such as a web browser program. Utilizing a well-known application protocol such as HTTP, the thin client connects to the VP. The VP then provides an executable program that is run on the thin client computer. The description of the VP's capabilities is encoded within the transferred program.

This executable program may be either in the native instruction set of the client computer, or in any other well-defined instruction set such as Java bytecode. The executable program may either be provided directly by the VP, but the executable program may also reside on another computer on the network requiring the client to retrieve the program from that source. Running the transferred program implements a UI on the client computer.

The UI may be intended for use only with VPs of a single type. In this case, to support heterogeneous VPs on a network, each VP must provide its own UI program to the host computer. Alternatively, each UI program may be capable of connection with and configuration of a heterogeneous set of VPs by itself, implementing either of the earlier-discussed implementations of this invention.

Other modifications and implementations will occur to those skilled in the art without departing from the spirit and the scope of the invention as claimed. Accordingly, the above description is not intended to limit the invention except as indicated in the following claims.

What is claimed is:

1. A method for configuring a machine vision system over a network, the machine vision system including a heterogeneous set of vision processors (VPs) and at least one host having a user interface (UI), the method comprising:
sending VP characteristic information over the network from a VP to a host having a UI; and
using the UI to configure the VP via the network.

2. The method of claim 1, wherein the VP characteristic information includes:
a plurality of VP characteristics.

3. The method of claim 1, wherein the VP characteristic information includes:
a plurality of VP identification codes; and
a plurality of functions executable on the VP.

4. The method of claim 1, wherein the VP characteristic information includes:
a VP identification code.

5. The method of claim 1, wherein the VP characteristic information includes:
an executable program.

6. The method of claim 5, wherein the executable program is adapted to configure a plurality of VP functions and parameters.

7. The method of claim 5, wherein the executable program is run on a thin client so as to provide a UI.

8. The method of claim 1, wherein the VP characteristic information includes:
a plurality of VP identification codes.

9. The method of claim 1, wherein the VP characteristic information includes:
a plurality of functions.

10. The method of claim 1, wherein sending VP characteristic information over the network includes:
connecting to the VP using a thin client.

11. The method of claim 10, wherein the thin client is a web browser.
